(19) United States
(12) Patent Application Publication
(10) Pub. No.: US 2006/0157999 A1
(43) Pub. Date: Jul. 20, 2006

(54) Compact lightweight handle for gripping and transporting hot cooking devices

(76) Inventor: Jeffrey Connor West, Columbia, SC (US)

Correspondence Address: Jeffrey West, 4840 Forest Dr. #319, Columbia, SC, 29206, US

(21) Appl. No.: 11/332,447

(22) Filed: Jan. 13, 2006

Related U.S. Application Data
(60) Provisional application No. 60/644,276, filed on Jan. 15, 2005.

(51) Int. Cl. A47J 45/00

(52) U.S. Cl. 294/118; 294/31.1

(57) ABSTRACT

The invention consists of a gripping device with two flat handles permanently secured together such that the flat sides are adjacent and freely pivot around a fastener. The ends farthest from the pivot point comprise a handle to be squeezed in the hand. The other ends are each bent and twisted in such a manner that one handle can pivot under the other handle, while the bends create a pair of matching jaws. The jaws are placed around a hot cooking utensil or other object and the handles are squeezed in the hand, thus firmly gripping the hot item, which can then be safely moved as desired without the user sustaining a burn.

### CROSS REFERENCE TO RELATED APPLICATIONS

The inventor claims any benefits for priority date from the filing of provisional application 60/644,276 for this invention filed on Jan. 15, 2005.

### STATEMENT REGARDING FEDERALLY SPONSORED RESEARCH OR DEVELOPMENT

Not applicable.

### REFERENCE TO A SEQUENCE LISTING, A TABLE, OR A COMPUTER PROGRAM LISTING COMPACT DISK APPENDIX

Not applicable.

### BACKGROUND OF THE INVENTION

This invention concerns the gripping, lifting and transportation of hot cooking utensils and devices to avoid burning by the user.

The process of cooking or boiling water necessitates the heating of the cooking utensil being used. Use of the heated contents normally requires that the cooking utensil have fixed permanent handles for pouring or other uses, which can make the cooking utensil bulky for use in the field. An alternate method of moving hot cookware is to use a gloved hand or a loose piece of material to insulate the user's hand from the hot item to prevent burning.

A third alternative is to pick the item up with a separate, portable handle. Such a device should provide for easy storage and flexibility in that multiple objects, such as various cooking utensils without permanent handles, can be moved.

Furthermore, some cooking devices such as stoves use thin sheet metal similar in construction to a pot or pan which also become hot during use. It can be difficult or impossible for the user to move these items while in use without sustaining burns. Under emergency conditions, such as if the stove were to tip over and create a fire hazard, there may be no way to safely move the hot device and rectify a dangerous situation.

There are commercially available gripping devices designed for picking up cookware, but all designs are inferior in that the jaws either mar expensive cooking utensils, are too heavy or bulky or do not sufficiently isolate the user from the heat source. Furthermore, the weight of the item to be lifted is limited by the construction design and material. While the invention in question is primarily designed for field use and as such would be constructed out of lightweight materials to lift light objects, the design nonetheless permits construction from light materials yet allows the lifting of heavy cooking utensils such as cast iron pans for frying. The said invention is not limited to outdoor use but can also be used in the kitchen.

### BRIEF SUMMARY OF THE INVENTION

The said invention is designed as a portable, lightweight handle to pick up multiple and various hot items such as cooking pots, pans or stoves. The device can prevent burns by the user who otherwise might have no available means to move such hot items. Therefore, utensils can be chosen for use without handles which provide for easier storage in situations where space is limited, such as under camping or military conditions.

Since cookware designed for such conditions is often manufactured from expensive metals for lightweight characteristics, the handle is designed so as to protect the condition of such valuable cookware.

The invention is also designed to provide handles of sufficient length to create a safe distance between the user and the heat source so as to isolate the user from the heat to preclude any possibility of burns from an open flame or otherwise.

The device is designed to be simply manufactured out of flat bar stock metal with a few twists and bends, by hand if necessary, and as such can be easily made without expensive tooling or other manufacturing costs. This provides the possibility of manufacture in poor areas of the world for the local population who often cook over open fires and need such items.

One end of the device forms a handle easily gripped in the user's hands, while the opposite ends are bent to a particular angle such that the jaws align together, and the two handles are fastened together at a pivot point. The resulting jaws form a wide surface suitable to grip the cooking utensil without marring.

### BRIEF DESCRIPTION OF THE SEVERAL VIEWS OF THE DRAWINGS

FIG. 1 of 3 shows the gripping device in the open position.

FIG. 2 of 3 shows the gripping device in the closed position.

FIG. 3 of 3 shows the invention in use firmly gripping the side of a cooking utensil.

### DETAILED DESCRIPTION OF THE INVENTION

Since the gripping device is primarily designed for use in the field under camping or military conditions where weight is a design consideration, the preferred material for construction is a lightweight metal such as aluminum or titanium. However, for other uses such as in the kitchen at home, a heavier metal could be utilized such as stainless steel. The invention is not restricted to any particular metal or alloy.

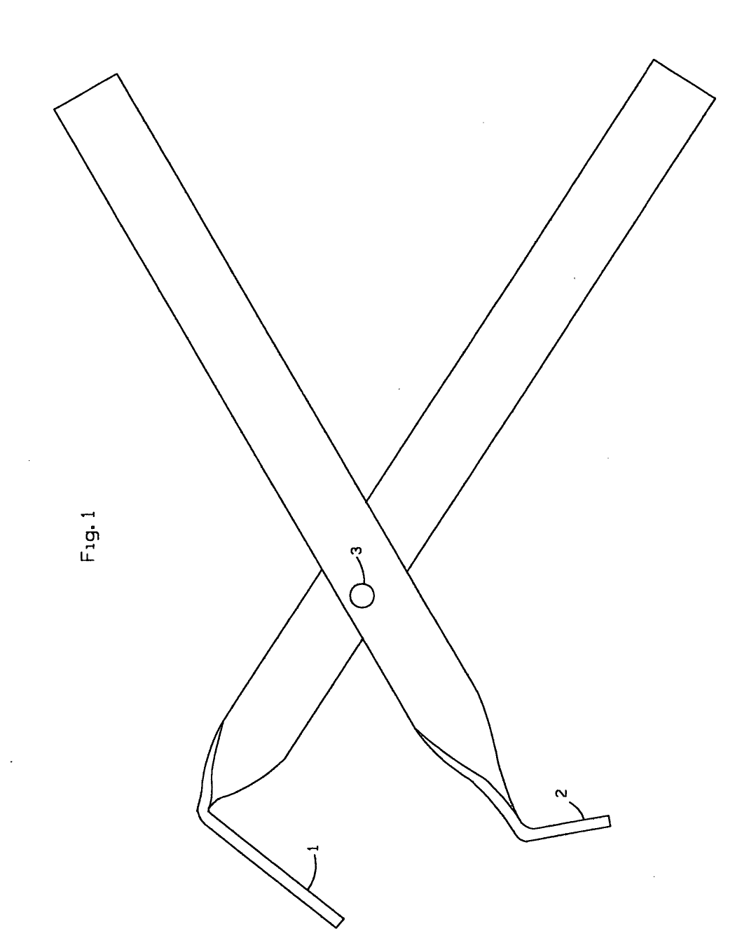

The gripping device is fastened out of two pieces of flat bar stock such that the handles 1 and 2 (FIG. 1) are oriented up and down to conform to the users hand. The ends of each handle opposite the hand grip are twisted over a different particular length. Handles 1 and 2 are each twisted approximately 90 degrees in the same direction. Handle 2 is twisted over a longer length as to allow handle 2 to pivot underneath handle 1.

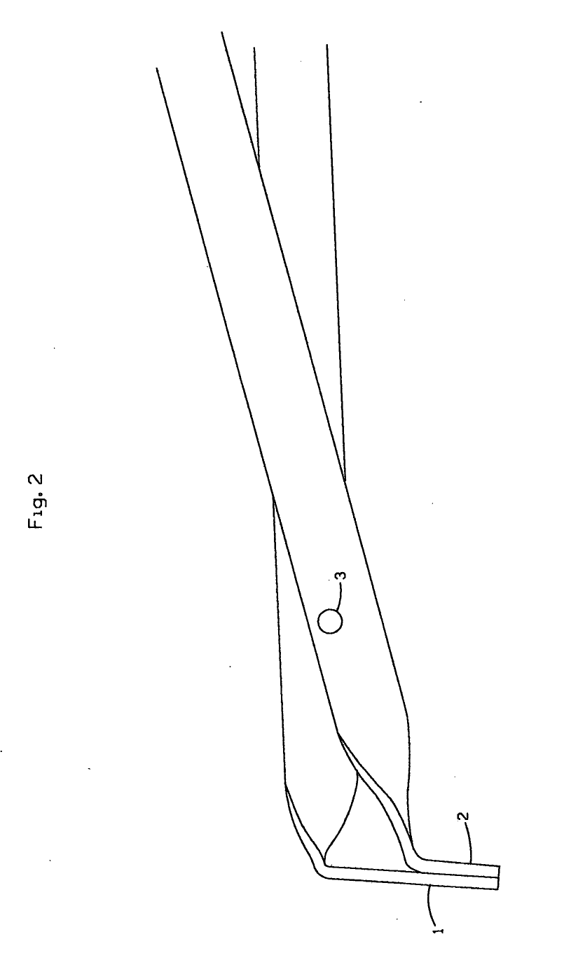

The handles are then bent from the twisted section to the end such that the pair forms matching jaws (FIG. 2). When closed, the flat surfaces of the jaws of handles 1 and 2 mate evenly together. By necessity the jaw of handle 1 will be longer and rest against the inside of the object to be lifted.

Fastener 3 holds the two flat handles 1 and 2 together firmly yet allows the handles to pivot.

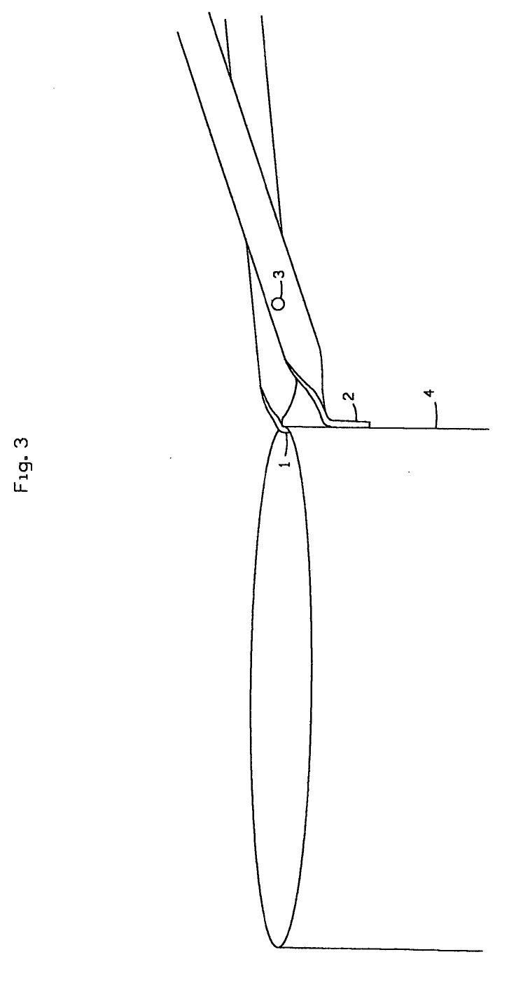

The device is operated by opening the jaws and placing handle 1 (FIG. 3) over the top side of the cooking utensil 4 to be lifted. The sides of the object must be relatively thin such as that of a pan or pot. The handles are then squeezed together between the fingers and palm of the user's hand at the opposite end. Handle 1 is grasped by the fingers while handle 2 rests firmly against the user's palm, thus bringing handle 2 firmly against the outside of cooking utensil 4 while handle 1 presses against the inside. The utensil can then be lifted and safely placed where desired by the user without being burned.

What is claimed is:

1. A gripping device consisting of two flat handles permanently affixed together with a pair of jaws at the end.

2. The gripping device of claim 1, wherein the two handles are affixed with the flat sides immediately adjacent to each other.

3. The handles of claim 2, wherein the handles are fastened together at a pivot point which secures the separate pieces together firmly but allows free rotation of the two pieces.

4. The gripping device of claim 1, wherein each handle is twisted approximately 90 degrees in the same direction at the end closest to the pivot point.

5. The handles of claim 4, wherein the two handles are twisted over a different length so as to allow one handle to pivot underneath the other.

6. The gripping device of claim 1, wherein each handle is bent at the end of the twist farthest from the pivot point to form a jaw which has a wide surface area to grip cooking utensils and other objects firmly but without marring or damage to said items.

7. The jaws of claim 6, wherein the angles of bending are such that when closed the handles project in a direction comfortable for use.

8. The jaws of claim 6, wherein the difference between the degree of bending in each handle is such that the handles are separated at the opposite ends by a distance comfortable for gripping by a normal human hand.

9. The jaws of claim 6, wherein the jaws of the handles are bent such that the two flat surfaces of the jaws mate together evenly.

10. The gripping device of claim 1, wherein the flat surfaces of the jaws can be placed over a hot cooking utensil or other object to be lifted and moved.

11. The gripping device of claim 1, wherein the handles are squeezed together with the hand to firmly grasp the item in question without burning the user.

12. The gripping device of claim 1, wherein the said object can be held firmly and turned at an angle such as to empty the contents safely.

13. The gripping device of claim 1, wherein the handles are of sufficient length to keep the user at a safe distance from the heat source.
